(19) United States
(12) Patent Application Publication
(10) Pub. No.: US 2015/0100378 A1
(43) Pub. Date: Apr. 9, 2015

(54) SUPPLY CHAIN MANAGEMENT METHOD AND SYSTEM

(71) Applicant: Caterpillar Inc., Peoria, IL (US)

(72) Inventors: Anthony James GRICHNIK, Eureka, IL (US); Thad Breton KERSH, Dunlap, IL (US)

(73) Assignee: Caterpillar Inc., Peoria, IL (US)

(21) Appl. No.: 14/046,026

(22) Filed: Oct. 4, 2013

(51) Int. Cl. G06Q 30/02; G06Q 10/08

(52) U.S. Cl. CPC G06Q 30/0202; G06Q 10/083
USPC 705/7.31

(57) ABSTRACT

A computer-implemented method for managing a supply chain including a central distribution center (DC) that distributes products to one or more edge DCs. The method may include determining, by one or more processors, a first rate of change of future demand for a product distributed by the edge DC over a predetermined future time horizon, and a second rate of change of historical demand for the product distributed by the edge DC over a historical time period. The method may also include updating flow of customer orders and storage space requirements for the central DC and the edge DC based on a difference between the first rate and the second rate.

### TECHNICAL FIELD

This disclosure relates generally to systems and methods for supply chain management, and more particularly, to systems and methods for supply chain management by inventory control and flow management.

### BACKGROUND

A supply chain may include distribution centers that store inventory of products needed to be supplied to customers in response to customer demands. Managing the flow between the inventories at these distribution centers may be essential to the success of many of today's companies. Most companies may rely on supply chain management to ensure the timely delivery of products in response to customer demands, such as to ensure the smooth functioning of different aspects of production, from the ready supply of components to meet production demands to the timely transportation of finished goods from the factory to the customer.

Customer demands may fluctuate due to various reasons, such as global economy and local economy. Sometimes, customer demands for certain products, such as replacement parts for certain machines, may slowly decrease to nearly zero. The slowly decreasing demand may trap excess product inventory at an edge distribution center which is remote from a central distribution center for several years or even longer, resulting in inefficient usage of storage space at the edge distribution center.

Certain techniques have been used to manage inventories. For example, U.S. Patent Publication No. 2011/0257991, to Shukla (the '991 publication), discloses a method for managing pharmacy inventories. The method includes maintaining an online pharmacy inventory database among a plurality of participating network pharmacies, identifying over-stock products, non-moving products, slow moving products, and un-wanted products from the plurality of participating network pharmacies, and generating a redistribution list of one or more products.

Although the method of the '991 publication may be useful for reducing or eliminating the generation of expired products, the method of the '991 publication requires redistributing or transferring products between two or more entities, resulting in additional transportation cost and handling cost.

The supply chain management system of the present disclosure is directed toward solving the problem set forth above and/or other problems of the prior art.

### SUMMARY

In one aspect, the present disclosure is directed to a computer-implemented method for managing a supply chain including a central distribution center (DC) that distributes products to one or more edge DCs. The method may include determining, by one or more processors, a first rate of change of future demand for a product distributed by the edge DC over a predetermined future time horizon, and a second rate of change of historical demand for the product distributed by the edge DC over a historical time period. The method may also include updating flow of customer orders and storage space requirements for the central DC and the edge DC based on a difference between the first rate and the second rate.

In another aspect, the present disclosure is directed to a supply chain management system for managing a supply chain including a central distribution center (DC) that distributes products to one or more edge DCs. The supply chain management system may include a processor and a memory module. The memory module may be configured to store instructions, that, when executed, enable the processor to determine a first rate of change of future demand for a product distributed by the edge DC over a predetermined future time horizon, and determine a second rate of change of historical demand for the product distributed by the edge DC over a historical time period. The processor may also be enabled to update flow of customer orders and storage space requirements for the central DC and the edge DC based on a difference between the first rate and the second rate.

In yet another aspect, the present disclosure is directed to a non-transitory computer-readable storage device. The storage device may store instructions for managing a supply chain including a central distribution center (DC) that distributes products to one or more edge DCs. The instructions may include determining a first rate of change of future demand for a product distributed by the edge DC over a predetermined future time horizon, and determining a second rate of change of historical demand for the product distributed by the edge DC over a historical time period. The instructions may also include updating flow of customer orders and storage space requirements for the central DC and the edge DC based on a difference between the first rate and the second rate.

### BRIEF DESCRIPTION OF THE DRAWINGS

FIG. 1 is a schematic illustration of an exemplary supply chain in which the supply chain management system consistent with the disclosed embodiments may be implemented.

FIG. 2 is a schematic illustration of an exemplary supply chain management system consistent with certain disclosed embodiments.

FIG. 3 is a graph illustrating historical and forecasted demand quantities of a product distributed by an edge DC as a non-limiting example.

FIG. 4 is a graph illustrating historical and forecasted demand quantities of a product distributed by an edge DC as another non-limiting example.

FIG. 5 is a graph illustrating historical and forecasted demand quantities of a product distributed by an edge DC as a further non-limiting example.

FIG. 6 is a flow chart illustrating an exemplary process for supply chain management consistent with a disclosed embodiment.

### DETAILED DESCRIPTION

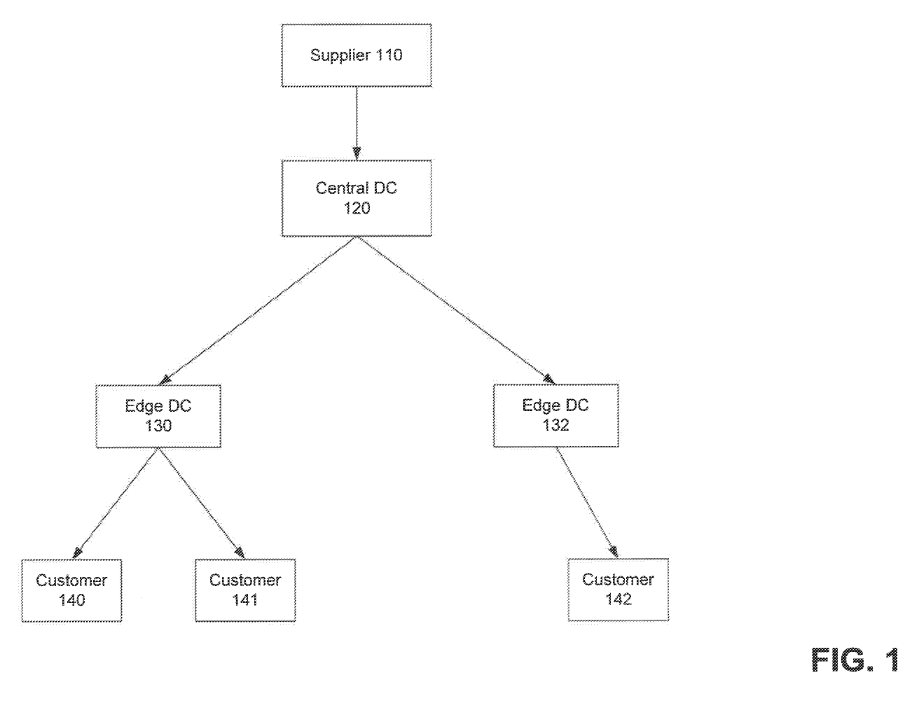

FIG. 1 illustrates an exemplary supply chain 100 in which the supply chain management system consistent with the disclosed embodiments may be implemented. As shown in FIG. 1, supply chain 100 may include a plurality of supply chain entities, such as a supplier 110, a central distribution center (DC) 120, edge DCs 130 and 132, and customers 140-142.

Supplier 110 may supply individual products to one or more of central DC 120, edge DCs 130 and 132, and customers 140-142. A product may represent any type of physical good that is designed, developed, manufactured, assembled, and/or delivered by supplier 110. Non-limiting examples of the product may include chemical products, mechanical products, pharmaceutical products, food, and components or replacement parts of fixed or mobile machines such as engines, tires, wheels, transmissions, pistons, rods, or shafts.

Central DC 120 may store products received from supplier 110, and may distribute the products to one or more of edge DCs 130 and 132, and customers 140-142. Edge DCs 130 and 132 may be located remotely from central DC 120, and may receive products distributed from central DC 120 and distribute the products to customers 140-142. In some embodiments, edge DC 132 may be a temporary edge DC which is temporarily established, or rented from another business entity, to accommodate for temporary surge of customer demands in a local area. In addition, in some embodiments, edge DC 130 may distribute the products to edge DC 132 which may subsequently distribute the products to customers 140-142.

Although supply chain 100 illustrated in FIG. 1 includes one supplier 110, one central DC 120, two edge DCs 130 and 132, and three customers 140-142, those skilled in the art will appreciate that supply chain 100 may include any number of suppliers, DCs, and customers.

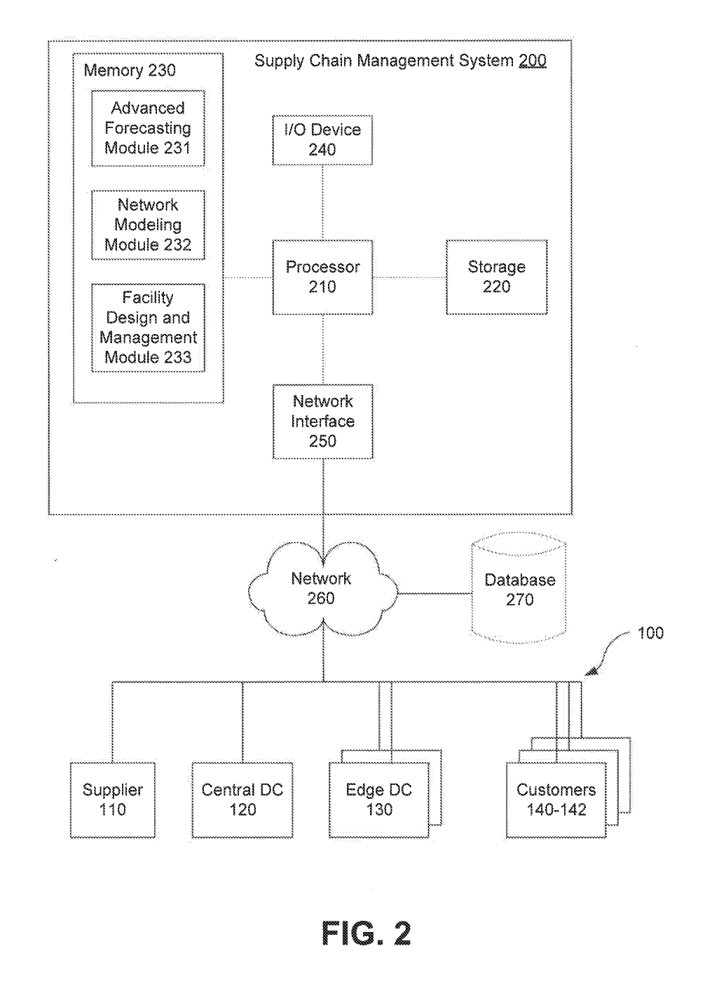

FIG. 2 illustrates an exemplary supply chain management system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to supply chain management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as supplier 110, central DC 120, edge DCs 130 and 132, and customers 140-142. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and method consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, and a facility design and management module 233.

Advanced forecasting module 231 may generate forecast information related to one or more products at any one of the supply chain entities based on historical data associated with the product. For example, advanced forecasting module 231 may forecast a future demand for a product at each one of edge DCs 130 and 132 based on respective historical demand data for that product at edge DCs 130 and 132. In addition, advanced forecasting module 231 may forecast a rate of change of future demand for the product at each one of edge DCs 130 and 132.

Network modeling module 232 may receive the forecasted information from advanced forecasting module 231 and simulate and optimize the flow of products between the supply chain entities in order to meet certain business goals of the entire organization that includes the supply chain entities. The business goal may include at least one of response time, profit, return on net assets, inventory turns, service level, and resilience. Network modeling module 232 may simulate the flow of products based on geographical locations of each one of the supply chain entities, the transportation methods (e.g., air, ship, truck, etc.), and link capacities (e.g., quantity of materials that can be transported via a certain route). Based on the simulation results and other information such as production costs, transportation costs, and regional sales price, and the like, network modeling module 232 may generate information such as gross revenue, cost of goods sold, and profit related to one or more products or parts.

Facility design and management module 233 may receive the forecasted information from advanced forecasting module 231 and the simulation results from network modeling module 232 and may determine the physical structure and dimension of one or more of central DC 120 and edge DCs 130 and 132. For example, facility design and management module 233 may receive forecasted information representing quantity of the incoming products to be received at central DC 120 and edge DCs 130 and 132. Based on this forecasted information, facility design and management module 233 may determine dimensions and locations of shelving, racks, aisles, and the like, of central DC 120 and edge DCs 130 and 132. Facility design and management module 233 may also determine the location of incoming items within central DC 120 and edge DCs 130 and 132, based on the forecasted information. Moreover, facility design and management module 233 may simulate the movement of resources (e.g., workers, machines, transportation vehicles, etc.) throughout central DC 120 and edge DCs 130 and 132. Still further, facility design and management module 233 may modify input information in order to achieve one or more of the business goals.

I/O device 240 may include one or more components configured to communication information associated with system 200. For example, I/O device 240 may include a console with an integrated keyboard and mouse to allow a user to input parameters associated with system 200 and/or data associated with the supply chain entities in supply chain 100. I/O device 240 may include one or more displays or other peripheral devices, such as, for example, printers, cameras, microphones, speaker systems, electronic tablets, bar code readers, scanners, or any other suitable type of I/O device 240.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain management.

Network 260 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with supply chain management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with supply chain management.

In the disclosed embodiments, it may be convenient to describe the method of supply chain management by using terms including future time horizon, time interval, historical time period, and rate of change of demand, which may be known in the art. The future time horizon is a predetermined period of time in the future during which the product demand, flow management, and inventory levels are evaluated in order to perform the supply chain management. The future time horizon may be specific to the product, and may be determined based on the cost and size of the product. For example, a future time horizon may be three months, a year, two years, or even five years from the current time. In addition, a product that is big and expensive may require constant evaluation and optimization on the product demand, flow management, and inventory levels, and therefore the future time horizon for the product may be relatively short. A time interval is a predetermined time resolution for the supply chain management. For example, a time interval may be one day, one month, or one quarter (i.e., a quarter year, or three months). A historical time period is a period of time immediately prior to the current time. A rate of change of demand for a product over a certain time period may be an average of rates of changes of demand quantities between two consecutive time intervals within the time period. Other averaging methods well known in the art, such as Auto Regressive Moving Average (ARMA), Auto Regressive Integrated Moving Average (ARIMA), and Exponential Weighted Moving Average (EWMA), etc., can also be applied where appropriate.

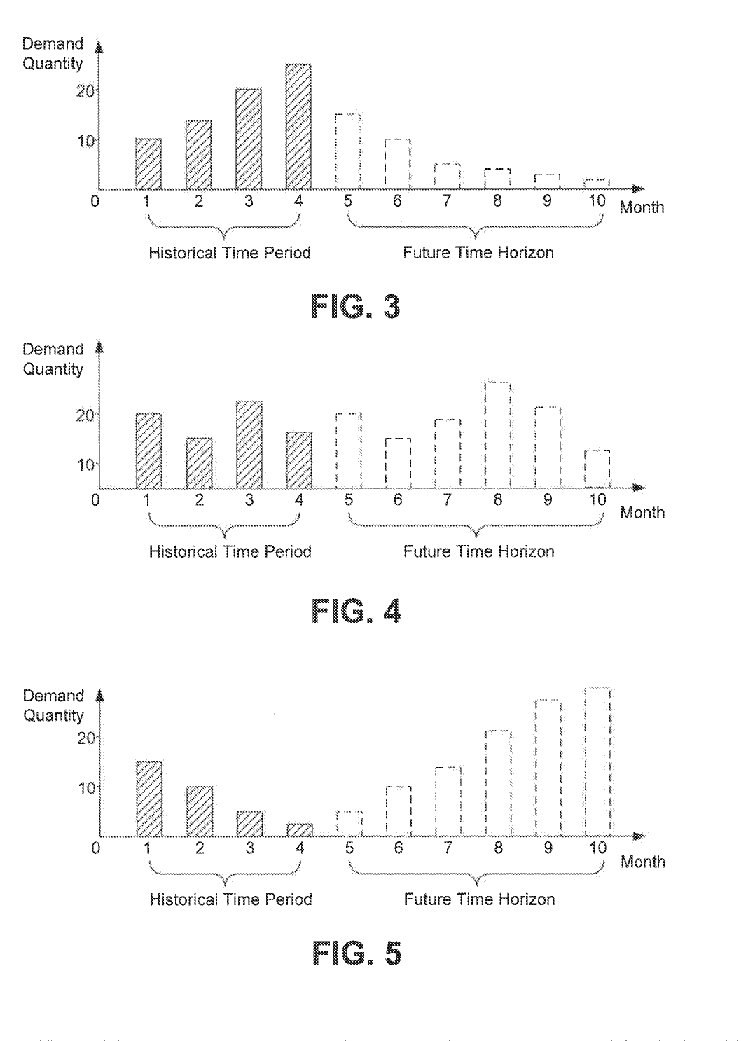

FIG. 3 is a graph illustrating historical and forecasted demand quantities of a product distributed by edge DC 130 over ten months, as a non-limiting example. In this example, the time interval is one month, the current time is at the end of Month 4, the historical time period is from the beginning of Month 1 through the end of Month 4, and the future time horizon is from the beginning of Month 5 through the end of Month 10. As illustrated in FIG. 3, the demand quantity of the product is 10 at Month 1, and 14 at Month 2. Therefore, the rate of change of demand for the product is 4/month between Month 1 and Month 2. Similarly, the rate of change of demand is 6/month between Month 2 and Month 3, and 5/month between Month 3 and Month 4. Therefore, the historical rate of change of demand for the product over the historical time period from Month 1 to Month 4 is 5/month. Similarly, the future rate of change of demand for the product over the future time horizon from Month 5 to Month 10 is about −3/month. A difference between the future rate and the historical rate is about −8/month.

FIG. 4 is a graph illustrating historical and forecasted demand quantities of a product distributed by edge DC 130 over ten months, as another example. As illustrated in FIG. 4, the rate of change of demand for the product is about −1/month over the historical time period from Month 1 to Month 4, and about −2/month over the future time horizon from Month 5 to Month 10. A difference between the future rate and the historical rate is about −1/month.

FIG. 5 is a graph illustrating historical and forecasted demand quantities of a product distributed by edge DC 130 over ten months, as another example. As illustrated in FIG. 5, the rate of change of demand for the product is about −4/month over the historical time period from Month 1 to Month 4, and about 5/month over the future time horizon from Month 5 to Month 10. A difference between the future rate and the historical rate is about 9/month.

A conventional supply chain management method may respond to the decreasing future demand at edge DC 130 by continuing to distribute the products from central DC 120, until the demand becomes zero. A problem with this conventional method is that, until there are actual orders from customers 140 and 141, the inventory of the product may be trapped at edge DC 130 for months or even years, taking up a large volume of storage space, which is not economically efficient. However, pulling the trapped inventory from edge DC 130 back to central DC 120 may require additional shipping and handling cost, which is not economically efficient either.

In the disclosed embodiments, when a difference between the future rate of change of demand for the product over the future time horizon and the historical rate of change of demand for the product over the historical time period is beyond a tolerance range, central DC 120 may stop distributing the product to edge DC 130. In this way, the trapping of the inventory at edge DC 130 may be prevented. For example, the tolerance range may be between −2/month and 2/month. Then, the difference illustrated in FIG. 3 is outside the tolerance range and the future demand is forecasted to decrease; the difference illustrated in FIG. 4 is within the tolerance range; and the difference illustrated in FIG. 5 is outside the tolerance range and the future demand is forecasted to increase.

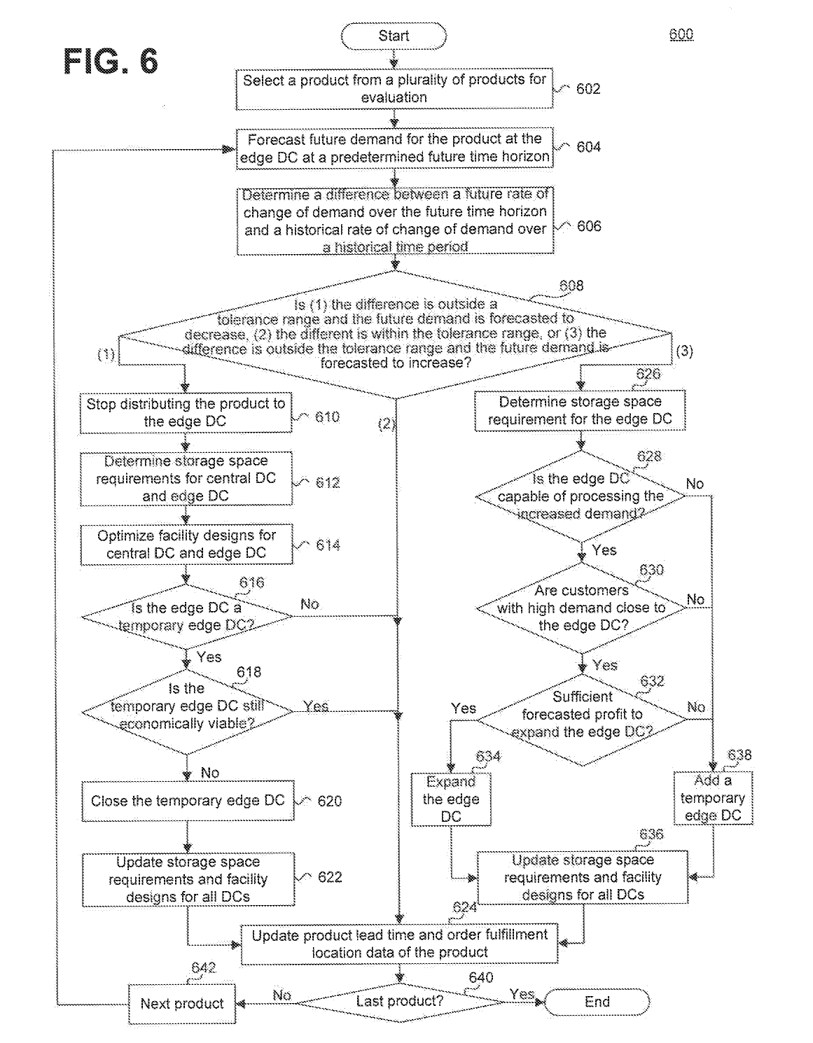

FIG. 6 is a flow chart illustrating an exemplary process 600 for supply chain management, consistent with a disclosed embodiment. As illustrated in FIG. 4, processor 210 may first select a product from a plurality of products for evaluation (step 602). The plurality of products may be distributed from central DC 120 to edge DC 130. Processor 210 may forecast future demand for the product distributed by edge DC 130 over a predetermined future time horizon (step 604). Then, processor 210 may determine a difference between a future rate of change of demand for the product distributed from edge DC 130 over the future time horizon and a historical rate of change of demand for the product distributed form edge DC 130 over a historical time period (step 606). Afterwards, processor 210 may determine whether (1) the difference between the future rate of change of demand and the historical rate of change of demand is outside the tolerance range and the future demand is forecasted to decrease, (2) the difference is within the tolerance range, or (3) the difference is outside the tolerance range and the future demand is forecasted to increase (step 608).

When the forecast of the customers' future orders are expected to decrease, and the difference between the future rate of change of demand and the historical rage of change of demand is outside the tolerance range, as illustrated in, for example, FIG. 3 (step 608, (1)). In this case, the product may be identified as a product with decelerating demand. Processor 210 may transmit instructions to central DC 120 to stop distributing the product to edge DC 130 (step 610). Then, processor 210 may determine the respective storage space requirements for central DC 120 and edge DC 130 over the future time horizon (step 612). For example, processor 210 may be enabled by facility design and management module 233 to determine the physical dimension of the storage space in central DC 120 needed to be increased to store the product that was originally planned to be distributed to edge DC 130. Processor 210 may also determine the physical dimension of the storage space in edge DC 130 that is no longer needed to store the product that was originally planned to be received from central DC 120. Next, processor 210 may optimize respective facility designs of central DC 120 and edge DC 130 based on the respective storage space requirements for central DC 120 and edge DC 130 (step 614). For example, processor 210 may determine the locations of shelving, racks, aisles, and the like, and the existing products and incoming products inside each one of central DC 120 and edge DC 130. Processor 210 may also determine the movement of resources (e.g., workers, machines, transportation vehicles, etc.) throughout each one of central DC 120 and edge DC 130.

After optimizing the facility designs for central DC 120 and edge DC 130, processor 210 may determine whether edge DC 130 is a temporary edge DC (step 616). If edge DC 130 is a temporary edge DC (step 616: Yes), processor 210 may determine whether the temporary edge DC is still economically viable (step 618).

For example, edge DC 130 may be a temporary edge DC 130 which is temporarily established to accommodate for the temporary surge of customer demands in a local area. When the customer demand decreases and the difference between the future rate of change of demand and the historical rate of change of demand is below a tolerance range, it is possible that it is no longer economically viable to operate temporary edge DC 130, and then temporary edge DC 130 needs to be closed. Processor 210 may determine whether temporary edge DC 130 is still economically viable by comparing the cost for maintaining temporary edge DC 130 to a total cost incurred by closing temporary edge DC 130. The total cost incurred by closing temporary edge DC 130 may include a switching cost, a transportation cost, and an inventory cost. The switching cost is the cost for closing temporary edge DC 130. The transportation cost includes the cost for transporting all of the remaining products in temporary edge DC 130 to central DC 120 or to edge DC 132, and the cost for transporting the products from central DC 120 or edge DC 132 to customers 140 and 141 that were previously receiving products from temporary edge DC 130. The inventory cost is the cost for storing the products received from temporary edge DC 130 in central DC 120 or edge DC 132.

When processor 210 determines that temporary edge DC 130 is not economically viable (step 618: No), processor 210 may transmit instructions to close temporary edge DC 130 (step 620). Then, processor 210 may update the storage space requirements for central DC 120 or edge DC 132 to store the remaining products previously stored in temporary edge DC 130 (step 622).

Next, processor 210 may determine the product lead time and order fulfillment location data for the selected product (step 624). The order fulfillment location data is the data related to the location of the product over the future time horizon. The product lead time is the time between the placement of an order and delivery of the product. The product lead time may include order processing time and shipping time. The product lead time may be determined by network modeling module 232 based on the order fulfillment location data.

On the other hand, if edge DC 130 is not a temporary edge DC (step 616, No), processor 210 may directly update the product lead time and order fulfillment location data for the selected product based on current information in the system (step 624). Similarly, if edge DC 130 is a temporary edge DC 130 which is still economically viable (step 618, Yes), processor 210 may also directly perform step 624.

When the customers' forecasted orders are not anticipated to change significantly, the difference between the future rate of change of demand and the historical rage of change of demand is within the tolerance range as illustrated in, for example, FIG. 4 (step 608, (2)). Then, processor 210 may directly determine the product lead time and order fulfillment location data for the selected product, without changing the structure of supply chain 100 (step 624).

When the customers' orders are forecasted to increase significantly, and the difference is outside the tolerance range as illustrated in, for example, FIG. 5 (step 608, (3)). In this case, processor 210 may determine a storage space requirement for edge DC 130 to store the product over the future time horizon (step 626). For example, processor 210 may determine the physical dimension of the storage space in edge DC 130 needs to be increased to store the increasing amount of incoming product due to the forecasted increase in customers' orders. Then, processor 210 may determine whether edge DC 130 is capable of processing future demand over the future time horizon (step 628). For example, processor 210 may determine the location of incoming items within edge DC 130, and simulate the movement of resources (e.g., workers, machines, transportation vehicles, etc.) throughout edge DC 130 for fulfilling the customers' orders, to determine whether edge DC 130 has the capability to handle the customers' future demand.

When processor 210 determines that edge DC 130 is capable of processing future demand over the future time horizon (step 628, Yes), processor 210 may determine whether customers with high future demand are located close to edge DC 130 (step 630). For example, processor 210 may determine whether a distance between edge DC 130 and the customers with high future demand for the product is shorter than a predetermined distance threshold, which in turn will affect the future order fulfillment time. If the customers with high future demand are located close to edge DC 130 (step 630, Yes), processor 210 may determine whether the business entity will achieve sufficient profit if edge DC 130 is expanded (step 632). For example, processor may determine whether a forecasted profit achieved by expanding the edge DC over a future time period for all of products to be evaluated is higher than a predetermined profit threshold. The future time period may be different from the future time horizon which is specific to the selected product, and may be determined based on the business operation mode of the entire business organization. If the forecasted profit is higher than the predetermined profit threshold (step 632, Yes), processor 210 may transmit instructions to expand edge DC 130 (step 634). Then, processor 210 may update storage space requirements and facility designs for all DCs (step 636). For example, processor 210 may determine the storage space requirement for central DC 120 to store the product over the future time horizon. Processor 210 may also optimize respective facility designs of central DC 120 and edge DC 130 based on the respective storage space requirements for central DC 120 and edge DC 130.

When processor 210 determines that edge DC 130 is not capable of processing future demand over the future time horizon (step 628, No), or the customers with high future demand are not located close to edge DC 130 (step 630, No), or the business entity will not achieve sufficient profit if edge DC 130 is expanded (step 632, No), processor 210 may transmit instructions to add a temporary edge DC close to the customers with the high future demand for the product (step 638). For example, processor 210 may transmit instructions to add temporary edge DC 132. Then, processor 210 may update storage space requirements and facility designs for all DCs (step 636). For example, processor 210 may determine the respective storage space requirements for central DC 120 and the newly added temporary edge DC 132 to store the product over the predetermined future time horizon. Processor 210 may also optimize the respective facility designs of central DC 120, edge DC 130, and temporary edge DC 132 based on the respective storage space requirements for central DC 120, edge DC 130, and temporary edge DC 132. After step 636, processor 210 may determine the product lead time and order fulfillment location data for the selected product (step 624).

After determining the product lead time and order fulfillment location data for the selected product, processor 210 may determine whether the selected product is the last one of the plurality of products to be evaluated (step 640). If the selected product is not the last one (step 640, No), processor 210 may select a next product (step 642). Then, process 600 may return back to step 604 where processor 210 forecasts the future demand for the next product distributed by edge DC 130 over the future time horizon. If the selected product is the last one (step 640, Yes), process 600 may be completed. Process 600 may be performed periodically (e.g., monthly, bi-monthly, quarterly, etc.), so that supply chain 100 is maintained in its optimized condition.

In the embodiment disclosed above, processor 210 may determine whether to add, or close, or expand a temporary edge DC based on the merits of a single product that is selected in step 602, if the selected product is large and costly to support such a change. Alternatively, in another embodiment, processor 210 may defer making the decision until all of the products have been evaluated, by evaluating the cumulative economic impacts and space requirement incurred by all of the products.

### INDUSTRIAL APPLICABILITY

The disclosed supply chain management system 200 may efficiently provide optimized supply chain designs for any business organization to achieve one or more desired business goals. Based on the disclosed system and methods, trapping of the slow moving products at the edge DCs may be prevented, and unnecessary cost for redistributing the products may be reduced.

It will be apparent to those skilled in the art that various modifications and variations can be made to the disclosed supply chain management system. Other embodiments will be apparent to those skilled in the art from consideration of the specification and practice of the disclosed supply chain management system. It is intended that the specification and examples be considered as exemplary only, with a true scope being indicated by the following claims and their equivalents.

What is claimed is:

1. A computer-implemented method for managing a supply chain including a central distribution center (DC) that distributes products to one or more edge DCs, the method comprising:
determining, by one or more processors, a first rate of change of future demand for a product distributed by the edge DC over a predetermined future time horizon;
determining, by the one or more processors, a second rate of change of historical demand for the product distributed by the edge DC over a historical time period; and
updating flow of customer orders and storage space requirements for the central DC and the edge DC based on a difference between the first rate and the second rate.

2. The method of claim 1, wherein the updating flow of customer orders and storage space requirements for the central DC and the edge DC includes, responsive to a determination that the difference between the first rate and the second rate is outside a tolerance range and the future demand is forecasted to decrease:
transmitting instructions to the central DC to stop distributing the product to the edge DC,
determining respective storage space requirements for the central DC and the edge DC to store the product at the central DC or the edge DC over the predetermined future time horizon,
optimizing respective facility designs of the central DC and the edge DC based on the respective storage space requirements for the central DC and the edge DC, and
updating product lead time and order fulfillment location data of the product.

3. The method of claim 2, further includes:
determining whether the edge DC is a temporary edge DC;
responsive to determining that the edge DC is a temporary edge DC, determining whether maintaining the temporary edge DC is economically viable; and
responsive to determining that maintaining the temporary edge DC is not economically viable:
transmitting instructions to close the temporary edge DC,
updating the storage space requirement for the central DC to store all of the products previously stored in the temporary edge DC, and
optimizing the facility design of the central DC based on the updated storage space requirement for the central DC.

4. The method of claim 3, further including determining whether maintaining the temporary edge DC is economically viable based on a switching cost, a transportation cost, and an inventory cost incurred by closing the temporary edge DC.

5. The method of claim 1, wherein the updating flow of customer orders and storage space requirements for the central DC and the edge DC includes, responsive to a determination that the difference between the first rate and the second rate is within the tolerance range:
updating product lead time and order fulfillment location data of the product.

6. The method of claim 1, wherein the updating flow of customer orders and storage space requirements for the central DC and the edge DC includes, responsive to a determination that the difference between the first rate and the second rate is outside a tolerance range and the future demand is forecasted to increase:
determining a storage space requirement for the edge DC to store the product at the edge DC over the predetermined future time horizon,
determining whether the edge DC is capable of processing future demand over the predetermined future time horizon,
responsive to determining that the edge DC is capable of processing the future demand over the predetermined future time horizon, determining whether a distance between the edge DC and customers with high future demand for the product is shorter than a predetermined distance threshold,
responsive to determining that the distance is shorter than the predetermined distance threshold, determining whether a forecasted profit of expanding the edge DC over a predetermined future time period for multiple products is higher than a predetermined profit threshold, and
responsive to determining that the forecasted profit is higher than the predetermined profit threshold:
transmitting instructions to expand the edge DC,
determining a storage space requirement for the central DC to store the product over the predetermined future time horizon,
optimizing respective facility designs of the central DC and the edge DC based on the respective storage space requirements for the central DC and the edge DC, and
updating product lead time and order fulfillment location data of the product.

7. The method of claim 6, further including, responsive to determining that the edge DC is not capable of processing the future demand over the predetermined future time horizon:
transmitting instructions to add a temporary edge DC close to the customers with the high future demand for the product,
determining respective storage space requirements for the central DC and the temporary edge DC to store the product over the predetermined future time horizon,
optimizing respective facility designs of the central DC, the edge DC, and the temporary edge DC based on the respective storage space requirements for the central DC, the edge DC, and the temporary edge DC, and
updating product lead time and order fulfillment location data of the product.

8. The method of claim 6, further including, responsive to determining that the distance between the edge DC and the customers with the high future demand for the product is longer than the predetermined distance threshold:
transmitting instructions to add a temporary edge DC close to the customers with the high future demand for the product,
determining respective storage space requirements for the central DC and the temporary edge DC to store the product over the predetermined future time horizon,
optimizing respective facility designs of the central DC, the edge DC, and the temporary edge DC based on the respective storage space requirements for the central DC, the edge DC, and the temporary edge DC, and
updating product lead time and order fulfillment location data of the product.

9. The method of claim 6, further including, responsive to determining that the forecasted profit is not higher than the predetermined profit threshold:
transmitting instructions to add a temporary edge DC close to the customers with the high future demand for the product,
determining respective storage space requirements for the central DC and the temporary edge DC to store the product over the predetermined future time horizon,
optimizing respective facility designs of the central DC, the edge DC, and the temporary edge DC based on the respective storage space requirements for the central DC, the edge DC, and the temporary edge DC, and
updating product lead time and order fulfillment location data of the product.

10. A supply chain management system for managing a supply chain including a central distribution center (DC) that distributes products to one or more edge DCs, comprising:
a processor; and
a memory module configured to store instructions, that, when executed, enable the processor to:
determine a first rate of change of future demand for a product distributed by the edge DC over a predetermined future time horizon;
determine a second rate of change of historical demand for the product distributed by the edge DC over a historical time period; and
update flow of customer orders and storage space requirements for the central DC and the edge DC based on a difference between the first rate and the second rate.

11. The system of claim 10, wherein the instructions stored in the memory module further enabling the processor to, responsive to a determination that the difference between the first rate and the second rate is outside a tolerance range and the future demand is forecasted to decrease:
transmit instructions to the central DC to stop distributing the product to the edge DC,
determine respective storage space requirements for the central DC and the edge DC to store the product at the central DC or the edge DC over the predetermined future time horizon,
optimize respective facility designs of the central DC and the edge DC based on the respective storage space requirements for the central DC and the edge DC, and
update product lead time and order fulfillment location data of the product.

12. The system of claim 11, wherein the instructions stored in the memory module further enabling the processor to:
determine whether the edge DC is a temporary edge DC;
responsive to determining that the edge DC is a temporary edge DC, determine whether maintaining the temporary edge DC is economically viable; and
responsive to determining that maintaining the temporary edge DC is not economically viable:
transmit instructions to close the temporary edge DC,
update the storage space requirement for the central DC to store all of the products previously stored in the temporary edge DC, and
optimize the facility design of the central DC based on the updated storage space requirement for the central DC.

13. The system of claim 12, wherein the instructions stored in the memory module further enabling the processor to:
determine whether maintaining the temporary edge DC is economically viable based on a switching cost, a transportation cost, and an inventory cost incurred by closing the temporary edge DC.

14. The system of claim 10, wherein the instructions stored in the memory module further enabling the processor to, responsive to a determination that the difference between the first rate and the second rate is within the tolerance range:
update product lead time and order fulfillment location data of the product.

15. The system of claim 10, wherein the instructions stored in the memory module further enabling the processor to, responsive to a determination that the difference between the first rate and the second rate is outside a tolerance range and the future demand is forecasted to increase:
determine a storage space requirement for the edge DC to store the product at the edge DC over the predetermined future time horizon,
determine whether the edge DC is capable of processing future demand over the predetermined future time horizon,
responsive to determining that the edge DC is capable of processing the future demand over the predetermined future time horizon, determine whether a distance between the edge DC and customers with high future demand for the product is shorter than a predetermined distance threshold,
responsive to determining that the distance is shorter than the predetermined distance threshold, determine whether a forecasted profit of expanding the edge DC over a predetermined future time period for multiple products is higher than a predetermined profit threshold, and
responsive to determine that the forecasted profit is higher than the predetermined profit threshold:
transmit instructions to expand the edge DC,
determine a storage space requirement for the central DC to store the product over the predetermined future time horizon,
optimize respective facility designs of the central DC and the edge DC based on the respective storage space requirements for the central DC and the edge DC, and
update product lead time and order fulfillment location data of the product.

16. The system of claim 15, wherein the instructions stored in the memory module further enabling the processor to, responsive to determining that the edge DC is not capable of processing the future demand over the predetermined future time horizon:
transmit instructions to add a temporary edge DC close to the customers with the high future demand for the product,
determine respective storage space requirements for the central DC and the temporary edge DC to store the product over the predetermined future time horizon,
optimize respective facility designs of the central DC, the edge DC, and the temporary edge DC based on the respective storage space requirements for the central DC, the edge DC, and the temporary edge DC, and
update product lead time and order fulfillment location data of the product.

17. The system of claim 15, wherein the instructions stored in the memory module further enabling the processor to, responsive to determining that the distance between the edge DC and the customers with the high future demand for the product is longer than the predetermined distance threshold:
transmit instructions to add a temporary edge DC close to the customers with the high future demand for the product,
determine respective storage space requirements for the central DC and the temporary edge DC to store the product over the predetermined future time horizon,
optimize respective facility designs of the central DC, the edge DC, and the temporary edge DC based on the respective storage space requirements for the central DC, the edge DC, and the temporary edge DC, and
update product lead time and order fulfillment location data of the product.

18. The method of claim 15, wherein the instructions stored in the memory module further enabling the processor to, responsive to determining that the forecasted profit is not higher than the predetermined profit threshold:
transmit instructions to add a temporary edge DC close to the customers with the high future demand for the product,
determine respective storage space requirements for the central DC and the temporary edge DC to store the product over the predetermined future time horizon,
optimize respective facility designs of the central DC, the edge DC, and the temporary edge DC based on the respective storage space requirements for the central DC, the edge DC, and the temporary edge DC, and
update product lead time and order fulfillment location data of the product.

19. A non-transitory computer-readable storage device storing instructions for managing a supply chain including a central distribution center (DC) that distributes products to one or more edge DCs, the instructions causing one or more computer processors to perform operations comprising:
determining a first rate of change of future demand for a product distributed by the edge DC over a predetermined future time horizon;
determining a second rate of change of historical demand for the product distributed by the edge DC over a historical time period; and
updating flow of customer orders and storage space requirements for the central DC and the edge DC based on a difference between the first rate and the second rate.

20. The computer-readable storage device of claim 19, the instructions further causing the one or more computer processors to perform operations including, responsive to a determination that the difference between the first rate and the second rate is outside a tolerance range and the future demand is forecasted to decrease:
transmitting instructions to the central DC to stop distributing the product to the edge DC,
determining respective storage space requirements for the central DC and the edge DC to store the product at the central DC or the edge DC over the predetermined future time horizon,
optimizing respective facility designs of the central DC and the edge DC based on the respective storage space requirements for the central DC and the edge DC, and
updating product lead time and order fulfillment location data of the product.
